(19) United States
(12) Patent Application Publication
(10) Pub. No.: US 2026/0036066 A1
(43) Pub. Date: Feb. 5, 2026

(54) TURBINE SHROUD ASSEMBLIES WITH ANGLED CHANNELS AND AIR ACTIVATED BUFFER CAVITY SEALS

(71) Applicant: Rolls-Royce Corporation, Indianapolis, IN (US)

(72) Inventors: Aaron D. Sippel, Indianapolis, IN (US); Ted J. Freeman, Indianapolis, IN (US); David J. Thomas, Indianapolis, IN (US); Clark J. Snyder, Indianapolis, IN (US); Grant Cook, Indianapolis, IN (US)

(21) Appl. No.: 18/680,568

(22) Filed: May 31, 2024

(51) Int. Cl. F01D 25/24; F01D 11/08

(52) U.S. Cl. CPC F01D 25/24; F01D 11/08; F05D 2240/14; F05D 2240/55; F05D 2260/36

(57) ABSTRACT

A turbine shroud assembly adapted for use with a gas turbine engine includes a carrier segment, a blade track segment, and a seal system. The carrier segment arranged circumferentially at least partway around an axis. The blade track segment is coupled to the carrier segment and defines a portion of a gas path of the gas turbine engine. The seal system includes seals arranged radially between the carrier segment and the blade track segment to block gases from flowing between the carrier segment and the blade track segment.

### FIELD OF THE DISCLOSURE

The present disclosure relates generally to turbine shroud assemblies, and more specifically to sealing of turbine shroud assemblies used with gas turbine engines.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Compressors and turbines typically include alternating stages of static vane assemblies and rotating wheel assemblies. The rotating wheel assemblies include disks carrying blades around their outer edges. When the rotating wheel assemblies turn, tips of the blades move along blade tracks included in static shrouds that are arranged around the rotating wheel assemblies. Such static shrouds may be coupled to an engine case that surrounds the compressor, the combustor, and the turbine.

Some shrouds positioned in the turbine may be exposed to high temperatures from products of the combustion reaction in the combustor. Such shrouds sometimes include components made from materials that have different coefficients of thermal expansion. Due to the differing coefficients of thermal expansion, the components of some turbine shrouds expand at different rates when exposed to combustion products. In some examples, sealing between and coupling such components may present challenges.

### SUMMARY

The present disclosure may comprise one or more of the following features and combinations thereof.

A turbine shroud assembly adapted for use with a gas turbine engine may include a carrier segment, a blade track segment, and a seal system. The carrier segment may be arranged circumferentially at least partway around an axis. The blade track segment may be arranged circumferentially at least partway around the axis to define a portion of a gas path of the gas turbine engine. The seal system may be arranged radially between the carrier segment and the blade track segment to block gases from flowing between the carrier segment and the blade track segment.

In some embodiments, the carrier segment may include an outer wall, a first support wall that extends radially inward from the outer wall, and a second support wall that extends radially inward from the outer wall. The second support wall may extend radially inward from the outer wall at a location spaced apart axially from the first support wall to define an attachment-receiving space. In some embodiments, the first support wall may be formed to include a radially-inwardly opening first channel, a radially-inwardly opening second channel spaced apart axially from the first channel, and at least one buffer air passageway that extends radially into the first support wall. The first channel and the second channel each extend circumferentially relative to the axis.

In some embodiments, the blade track segment may include a shroud wall and an attachment feature. The shroud wall may extend circumferentially partway around the axis. The attachment feature may extend radially outward from the shroud wall into the attachment-receiving space formed in the carrier segment.

In some embodiments, the seal system may include a buffer air seal assembly located radially between the carrier segment and the shroud wall of the blade track segment to block gases from flowing between the carrier segment and the blade track segment into the attachment-receiving space of the carrier segment. The buffer air seal assembly may include a first seal member arranged in the first channel and engaged with the shroud wall and a second seal member arranged in the second channel and engaged with the shroud wall.

In some embodiments, the at least one buffer air passageway discharges buffer air radially inward axially between the first and second seal members into the first channel and the second channel. The at least one buffer air passageway discharges buffer air radially inward axially between the first and second seal members into the first channel and the second channel to urge the first seal member radially inward and axially forward and the second seal member radially inward and axially aft into engagement with the carrier segment and the blade track segment.

In some embodiments, the first and second channel cooperate to define a partition wall formed in the first support wall axially therebetween. The partition wall may extend circumferentially relative to the axis.

In some embodiments, the at least one buffer air passageway may extend radially through the partition wall. The at least one buffer air passageway may extend radially through the partition wall axially between the first channel and the second channel.

In some embodiments, the at least one buffer air passageway includes a first buffer air passageway and a second buffer air passageway. The first buffer air passageway may extend radially into the first support wall and opens into the first channel. The second buffer air passageway may extend radially into the forward support wall and opens into the second channel.

In some embodiments, the first channel may be defined by a first partition-wall surface of the partition wall and a first angled surface. The first partition-wall surface of the partition wall may extend radially outward from a terminal end of the partition wall and curve axially forward moving radially outward. The first angled surface may extend radially inward and axially forward from the first partition-wall surface.

In some embodiments, the second channel may be defined by a second partition-wall surface of the partition wall and a second angled surface. The second partition-wall surface may extend radially outward from the terminal end of the partition wall and curve axially aft moving radially outward. The second angled surface may extend radially inward and axially aft from the second partition-wall surface.

In some embodiments, the first seal member and the second seal member may each comprise a single strand of solid metallic material. In some embodiments, the first seal member may include a single strand of solid metallic material. In some embodiments, the second seal member may include a single strand of solid metallic material.

In some embodiments, the second support wall may be formed to include a radially-inwardly opening third channel. The third channel may extend circumferentially relative to the axis. The turbine shroud assembly may further include a third seal member arranged in the third channel.

In some embodiments, the turbine shroud assembly may further include at least one retainer. The at least one retainer may extend axially into the carrier segment and through the attachment feature of the blade track segment so as to couple the blade track segment to the carrier segment.

According to another aspect of the present disclosure, a method may include providing a carrier segment, providing a blade track segment, and providing a buffer air seal assembly. The carrier segment may be arranged circumferentially at least partway around an axis. The blade track segment may be arranged circumferentially at least partway around the axis.

In some embodiments, the carrier segment formed to include a radially-inwardly opening first channel, a radially-inwardly opening second channel spaced apart axially from the first channel, and at least one buffer air passageway. The at least one buffer air passageway may extend radially into the carrier segment.

In some embodiments, the blade track segment may have a shroud wall and an attachment feature. The shroud wall may extend circumferentially partway around the axis. The attachment feature may extend radially outward from the shroud wall.

In some embodiments, the buffer air seal assembly may include a first seal member and a second seal member. The first seal member and the second seal member may each extend circumferentially relative to the axis.

In some embodiments, the method may further include arranging the first seal member of the buffer air seal assembly in the first channel formed in the carrier segment. In some embodiments, the method may further include arranging the second seal member of the buffer air seal assembly in the second channel formed in the carrier segment.

In some embodiments, the method may further include arranging the blade track segment adjacent to the carrier segment. The method may further include arranging the blade track segment adjacent to the carrier segment so that the buffer air seal assembly is radially between the carrier segment and the shroud wall of the blade track segment to block gases in the gas path from flowing between the carrier segment and the blade track segment.

In some embodiments, the method may further include discharging a flow of buffer air through the at least one buffer air passageway. The method may include discharging a flow of buffer air through the at least one buffer air passageway axially between the first and second seal members into the first channel and the second channel to urge the first seal member radially inward and axially forward and the second seal member radially inward and axially aft into engagement with the carrier segment and the blade track segment.

In some embodiments, the first and second channel may cooperate to define a partition wall formed in the carrier segment axially therebetween. The partition wall may extend circumferentially relative to the axis.

In some embodiments, the at least one buffer air passageway may extend radially through the partition wall. The at least one buffer air passageway may extend radially through the partition wall axially between the first channel and the second channel.

In some embodiments, the at least one buffer air passageway includes a first buffer air passageway and a second buffer air passageway. The first buffer air passageway may extend radially into the carrier segment and opens into the first channel. The second buffer air passageway may extend radially into the carrier segment and opens into the second channel.

In some embodiments, the first channel is defined by a first partition-wall surface of the partition wall and a first angled surface. The first partition-wall surface of the partition wall may extend radially outward from a terminal end of the partition wall and curve axially forward moving radially outward. The angled surface may extend radially inward and axially forward from the first partition-wall surface,

In some embodiments, the second channel may be defined by a second partition-wall surface of the partition wall and a second angled surface. The second partition-wall surface of the partition wall may extend radially outward from the terminal end of the partition wall and curve axially aft moving radially outward. The second angled surface may extend radially inward and axially aft from the second partition-wall surface.

In some embodiments, the first seal member and the second seal member may each comprise a single strand of solid metallic material. In some embodiments, the first seal member may include a single strand of solid metallic material. In some embodiments, the second seal member may include a single strand of solid metallic material.

In some embodiments, the method may further comprise providing a third seal member. In some embodiments, the method may further comprise arranging the third seal member in a radially-inwardly opening third channel formed in the carrier segment.

In some embodiments, the method may further include providing at least one retainer and inserting the at least one retainer axially into the carrier segment and through the attachment feature of the blade track segment. The method may include inserting the at least one retainer axially into the carrier segment and through the attachment feature of the blade track segment to couple the blade track segment to the carrier segment.

These and other features of the present disclosure will become more apparent from the following description of the illustrative embodiments.

### BRIEF DESCRIPTION OF THE DRAWINGS

FIG. 1 is a cut-away perspective view of a gas turbine engine showing that the exemplary engine includes a fan, a compressor, a combustor, and a turbine and suggesting that the turbine includes turbine wheel assemblies and static vane assemblies surrounded by a turbine shroud assembly;

FIG. 2 is a partial cross-sectional view of the gas turbine engine of FIG. 1 showing a portion of the turbine in which the turbine shroud assembly is located radially outward from blades of a turbine wheel assembly to block gasses from passing over the blades without interacting with the blades, and further showing the turbine shroud assembly includes a carrier segment, a blade track segment coupled to the carrier segment to define a portion of a gas path of the gas turbine engine, and a seal system configured to seal between the carrier segment and the blade track segment to block gases flowing through the gas path from flowing between the carrier segment and the blade track segment;

FIG. 3 is a perspective view of a portion of the turbine shroud assembly of FIG. 2 showing the turbine shroud assembly includes the carrier segment and the blade track segment made from ceramic matrix composite materials coupled to the carrier segment;

FIG. 4 is an exploded view of the turbine shroud assembly of FIG. 3 showing the seal system includes a forward seal assembly having first and second seal members configured to be arranged in respective channels formed in the carrier segment and an aft seal assembly having a plurality of seal members configured to be arranged in a respective channel formed in the carrier segment;

FIG. 5 is a cross-section view of the turbine shroud assembly of FIG. 3 taken along line 5-5 showing the forward support wall of the carrier segment is formed to include a radially-inwardly opening first channel that receives the first seal member included in the forward seal assembly, a radially-inwardly opening second channel spaced apart axially from the first channel that receives the second seal member included in the forward seal assembly, and a buffer air passageway configured to discharge buffer air into the space axially between the seal members, and further showing the aft support wall of the carrier segment is formed to include a radially-inwardly opening third channel that receives the seal members included in the aft seal assembly;

FIG. 6 is a detail view of FIG. 5 showing the forward seal assembly—also referred to as the buffer air seal assembly-includes the first seal arranged in the first channel and the second seal arranged in the second channel so that buffer air is discharged axially between the two seals to urge the first seal member radially inward and axially forward and the second seal member radially inward and axially aft into engagement with the carrier segment and the blade track segment;

FIG. 7 is a cross-section view of the turbine shroud assembly of FIG. 3 taken along line 7-7 showing the forward support wall is formed to include a plurality of buffer air passageways spaced apart circumferentially about the axis, and further showing each buffer air passageway extends radially into the forward support wall of the carrier segment from a cavity formed in the outer wall of the carrier segment;

FIG. 8 is a cross-section view of another turbine shroud assembly similar to the turbine shroud assembly of FIG. 5 showing the forward support wall of the carrier includes two buffer air passageways with a first buffer air passageway opening into the first channel and a second buffer air passageway opening into the second channel to discharge buffer air axially between the two seals to urge the first seal member radially inward and axially forward and the second seal member radially inward and axially aft into engagement with the carrier segment and the blade track segment; and

FIG. 9 is a detail view of FIG. 8 showing the forward seal assembly—also referred to as the buffer air seal assembly—includes the first seal arranged in the first channel and the second seal arranged in the second channel with the first buffer air passageway opening into the first channel and the second buffer air passageway opening into the second channel.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

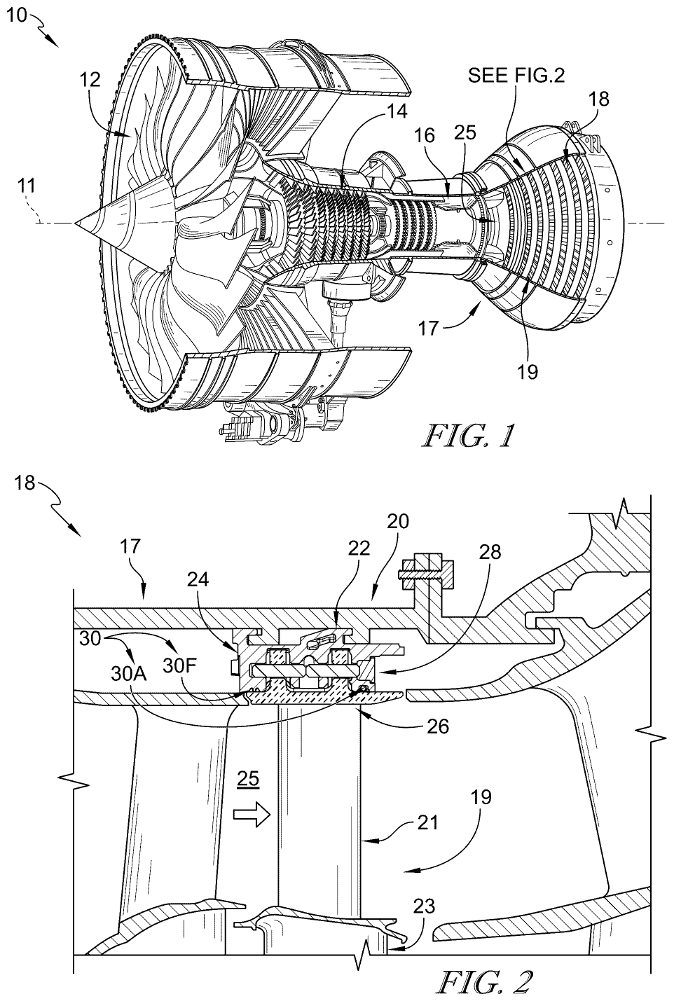

A turbine shroud segment 22 is shown in FIGS. 2-6 and is adapted for use in a gas turbine engine 10 as shown in FIG. 1. The turbine shroud segment 22 includes a carrier segment 24 arranged circumferentially at least partway around an axis 11 of the gas turbine engine 10, a blade track segment 26 arranged circumferentially at least partway around the axis 11, a mount system 28 configured to couple the carrier segment 24 to the blade track segment 26, and a seal system 30 as shown in FIGS. 2-6. The seal system 30 is configured to seal gaps between the carrier segment 24 and the blade track segment 26 to prevent or block gases from a gas path 25 of the gas turbine engine 10 from flowing between the carrier segment 24 and the blade track segment 26.

The blade track segment 26 is a ceramic matrix composite component configured to directly face the high temperatures of the gas path 25 of the gas turbine engine 10 to define a portion of the gas path 25. The carrier segment 24 is a metallic support component configured to interface with other metallic components of the gas turbine engine 10, such as the case 17, to support the blade track segment 26 to radially locate the blade track segment 26 relative to the axis 11. The mount system 28 includes at least one retainer 78, 80, and illustratively the mount system 28 includes two retainers 78, 80 that each extend axially into the blade track segment 26 and the carrier segment 24 to couple the blade track segment 26 to the carrier segment 24. The seal system 30 is arranged radially between the carrier segment 24 and the blade track segment 26 to seal a cavity 48 (sometimes referred to as an attachment-receiving space) defined by the carrier segment 24 to block gases from flowing between the carrier segment 24 and the blade track segment 26 and into the cavity 48.

The seal system 30 includes a forward seal assembly 30F located radially between the carrier segment 24 and the blade track segment 26 on a forward side of the blade track segment 26 and an aft seal assembly 30A located radially between the carrier segment 24 and the blade track segment 26 on an aft side of the blade track segment 26. The forward seal assembly 30F includes a first seal 32 and a second seal 34 each arranged in a corresponding channel 52, 54 formed in the carrier segment 24. The aft seal assembly 30A includes a plurality of seal members 36A, 36B, 36C arranged in the third channel 56 formed in the carrier segment 24.

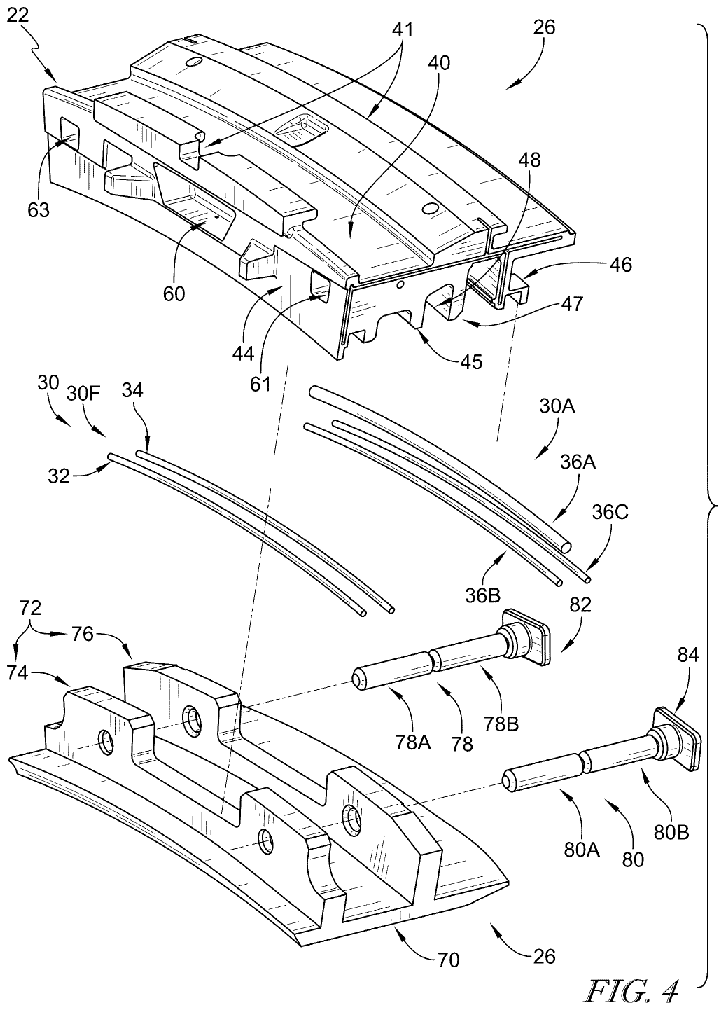

The forward seal assembly 30F includes a first seal member 32 and a second seal member 34 as shown in FIGS. 4-7. The first seal member 32 and the second seal member 34 each extend circumferentially about the axis 11. Each seal member 32, 34 is arranged in a corresponding radially-inward opening channel 52, 54 formed in the carrier segment 24.

During operation of a gas turbine engine 10, the hot, high-pressure products directed into the turbine 18 from the combustor 16 flow across a radially-inwardly opening surface of a shroud wall 70 of the blade track segment 26 that defines a portion of the gas path 25. The seal system 30 blocks the hot, high-pressure products from flowing into the cavity 48 of the turbine shroud segment 22. Some turbine shroud assemblies use seals having at least two seal members, where one of the seals is configured to be compressed between the carrier segment 24 and the blade track segment 26 to bias the other seal member(s) into engagement with the shroud wall 70 of the blade track segment 26, thereby improving the seal therebetwen.

In some embodiments, the carrier segment 24 may also include buffer air passageways to direct relatively high-pressure air (sometimes referred to as buffer air) into the channel(s) formed in the carrier segment 24 to distribute the high-pressure air along the seal members. The high-pressure air supplied to the channel(s) is used help keep the gases in the gas path 25 out of the cavity 48 in the event of a seal failure. The high-pressure or buffer air is usually jetted through the seal members arranged in the channel(s), which may cause the seal members to wear, specifically oxidize, significantly reducing the overall life of the seal members and the effectiveness of the seal members.

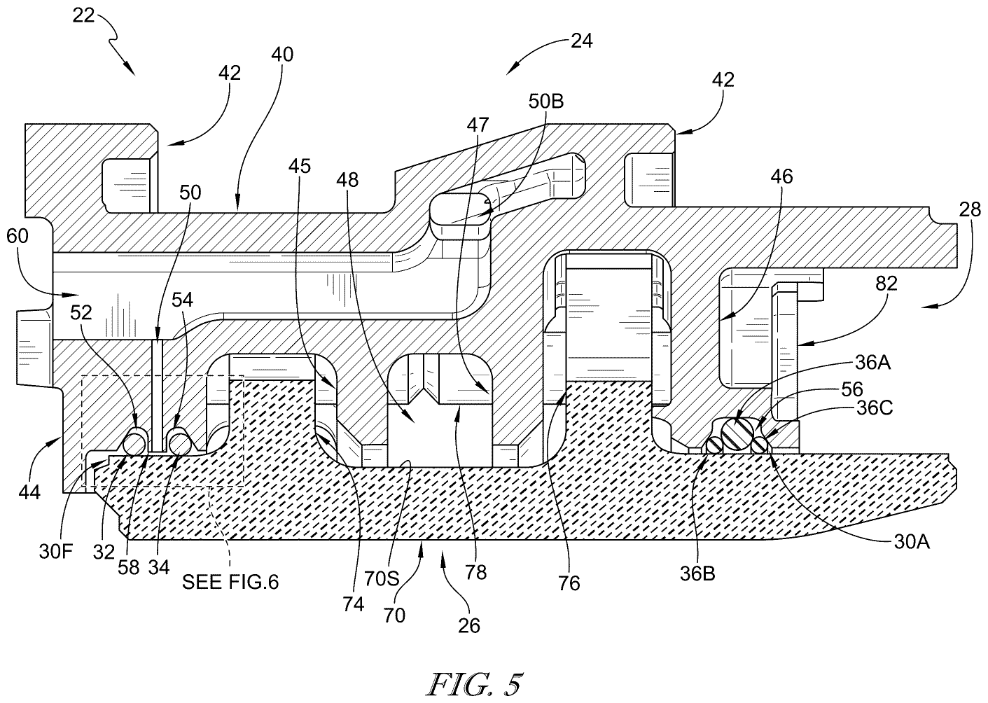

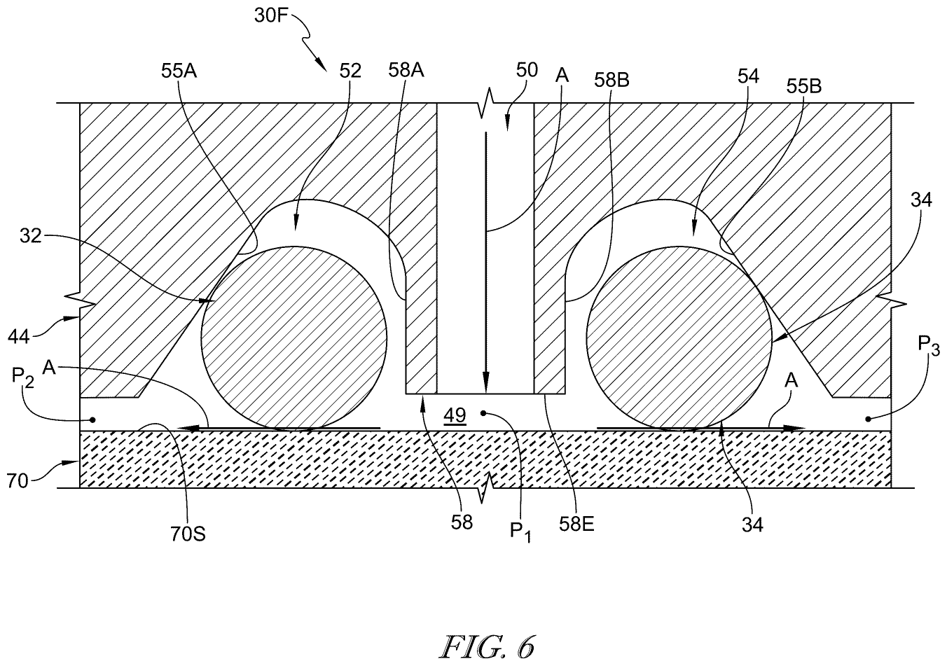

Instead of using another seal member to urge the other seal member(s) into engagement with the shroud wall 70 of the blade track segment 26, the forward seal assembly 30F—also referred to as the buffer air seal assembly 30F—is pressure-activated. Each of the seal members 32, 34 are arranged in their own discrete channel 52, 54. The buffer air is discharged axially between the first and second seals 32, 34 into the first and second channels 52, 54 as suggested by the arrows A in FIGS. 5 and 6.

The buffer air discharged into the first and second cavities 52, 54 pressurizes the space or buffer air cavity 49 axially between the first and second seal members 32, 34 to urge the first seal member 32 radially inward and axially forward and the second seal member 34 radially inward and axially aft into engagement with the carrier segment 24 and the blade track segment 26. This eliminates the need for a compressible seal member to bias the seal members 32, 34 into engagement with the blade track segment 26. The pressure activation of the buffer air seal assembly 30F causes the first seal member 32 to be urged radially inward and axially forward and causes the second seal member 34 to be urged radially inward and axially aft.

Additionally, the shape of the discrete channels 52, 54 formed in the carrier segment 24 produce a venturi effect as the buffer air is supplied to the channels 52, 54, which causes the seal members 32, 34 to be sucked or pulled into engagement with the carrier segment 24 and the blade track segment 26. This increases the effectiveness of the seal members 32, 34 as sealing between the carrier segment 24 and the blade track segment 26.

The buffer air seal assembly 30F includes a first seal member 32 arranged in a first radially-inwardly opening channel 52 formed in the carrier segment 24 and a second seal member 34 arranged in a second radially-inwardly opening channel 54 formed in the carrier segment 24 as shown in FIGS. 5 and 6. The first channel 52 is spaced apart axially from the second channel 54 to define a partition wall 58 therebetween.

At least one buffer air passageway 50, 51, 53 extends radially through partition wall 58 of the carrier segment 24 axially between the first and second channels 52, 54. The buffer air passageway 50, 51, 53 discharges the buffer air axially between the first channel 52, i.e. the first seal 32, and the second channel 54, i.e. the second seal 34 as shown in FIGS. 5 and 6.

The first and second seal members 32, 34 are each a wire seal or a single strand of solid metallic material in the illustrative embodiment. In some embodiments, the first and second seal members 32, 34 are another suitable seal type.

The channels 52, 54 formed in the carrier segment 24 are shaped so that to induce a venturi effect to pull the seal members 32, 34 into engagement with an outer surface 70S of the shroud wall 70 of the blade track segment 26 and the carrier segment 24 as shown in FIGS. 5 and 6. In the illustrative embodiment, the first and second channels 52, 54 each have a half-heart shape as shown in FIGS. 5 and 6.

The first channel 52 is defined by a first partition-wall surface 58A of the partition wall 58 and an angled surface 55A as shown in FIG. 6. The first partition-wall surface 58A extends radially outward from a terminal end 58E of the partition wall 58 and curves axially forward moving radially outward. The angled surface 55A extends radially inward and axially forward from the first partition-wall surface 58A. In the illustrative embodiment, the first partition-wall surface 58A curves radially inward slightly and the angled surface 55A extends radially inward and axially forward from the first partition-wall surface 58A as shown in FIG. 5.

The second channel 54 is defined by a second partition-wall surface 58B of the partition wall 58 and an angled surface 55B as shown in FIG. 6. The second partition-wall surface 58B extends radially outward from a terminal end 58E of the partition wall 58 and curves axially aft moving radially outward. The angled surface 55B extends radially inward and axially forward from the second partition-wall surface 58B.

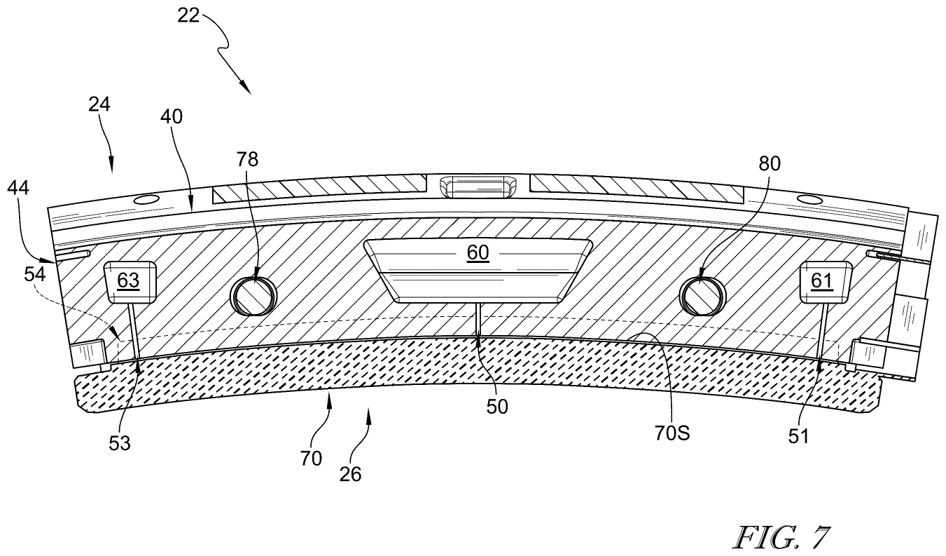

The buffer air passageways 50, 51, 53 extend radially through the partition wall 58 axially between the first channel 52 and the second channel 54 as shown in FIGS. 5 and 6. The buffer air passageways 50, 51, 53 are spaced apart circumferentially about the axis 11 as shown in FIG. 7.

With the seal system 30 of the present disclosure initially described above, the gas turbine engine 10 is now described in more detail. The gas turbine engine 10 includes a fan 12, a compressor 14, a combustor 16, and a turbine 18 as shown in FIG. 1. The fan 12 is driven by the turbine 18 and provides thrust for propelling an air vehicle. The compressor 14 compresses and delivers air to the combustor 16. The combustor 16 mixes fuel with the compressed air received from the compressor 14 and ignites the fuel. The hot, high-pressure products of the combustion reaction in the combustor 16 are directed into the turbine 18 to cause the turbine 18 to rotate about an axis 11 and drive the compressor 14 and the fan 12. In some embodiments, the fan may be replaced with a propeller, drive shaft, or other suitable configuration.

The turbine 18 includes at least one turbine wheel assembly 19 and a turbine shroud 20 positioned to surround the turbine wheel assembly 19 as shown in FIGS. 1 and 2. The turbine wheel assembly 19 includes a plurality of blades 21 coupled to a rotor disk 23 for rotation with the disk 23. The hot, high pressure combustion products from the combustor 16 are directed toward the blades 21 of the turbine wheel assemblies 19 along the gas path 25. The turbine shroud 20 is coupled to the outer case 17 of the gas turbine engine 10 and extends around the turbine wheel assembly 19 to block gases from passing over the turbine blades 21 during use of the turbine 18 in the gas turbine engine 10.

In the illustrative embodiment, the turbine shroud 20 is made up of a number of turbine shroud segment assemblies 22 that each extend circumferentially partway around the axis 11 and cooperate to surround the turbine wheel assembly 19. In other embodiments, the turbine shroud 20 is annular and non-segmented to extend fully around the axis 11 and surround the turbine wheel assembly 19. In yet other embodiments, certain components of the turbine shroud 20 are segmented while other components are annular and non-segmented.

Each turbine shroud segment 22 includes the carrier segment 24, blade track segment, the mount system 28, and the seal system 30 as shown in FIGS. 2-6. The carrier segment 24 and the blade track segment 26 are arranged circumferentially partway about the axis 11. The blade track segment 26 includes the shroud wall 70 that extends circumferentially partway around the axis 11 to define a portion of the gas path 25 and an attachment feature 72 that extends radially from the shroud wall 70 into the cavity 48 of the carrier segment 24. The mount system 28 is configured to couple the blade track segment 26 to the carrier segment 24. The seal system 30 is arranged radially between the carrier segment 24 and the blade track segment 26 to seal gaps therebetween.

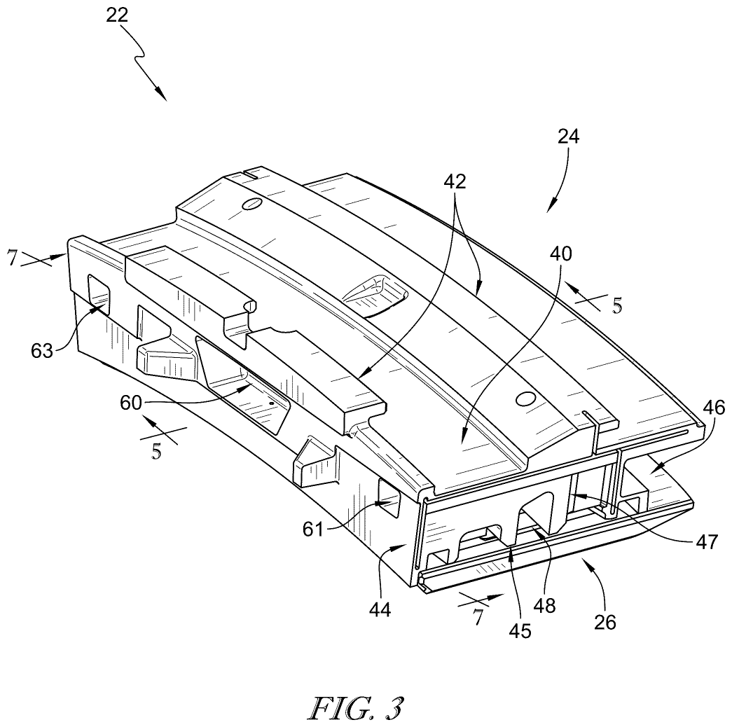

The carrier segment 24 includes an outer wall 40, a pair of hangers 42, a forward support wall 44, and an aft support wall 46 as shown in FIGS. 3-6. The outer wall 40 extends circumferentially at least partway about the axis 11. The hangers 42 extend radially outward from the outer wall 40 and engage the case 17 to couple the turbine shroud segment 22 to the rest of the engine 10. The forward support wall 44 extends radially inward from the outer wall 40 at a forward end of the outer wall 40 axially forward of the attachment feature 72 and the aft support wall 46 extends radially inward from the outer wall 40 at an aft end of the outer wall 40 axially aft of the attachment feature 72.

In the illustrative embodiment, the carrier segment 24 further includes a first intermediate support wall 45 and a second intermediate support wall 47 as shown in FIGS. 3, 4, and 6. The first intermediate support wall 45 and the second intermediate support wall 47 each extend radially inward from the outer wall 40 of the carrier segment 24 axially between the first and second support walls 44, 46. The second intermediate support wall 47 is spaced apart axially from the first intermediate support wall 45 in the illustrative embodiment.

The forward and aft support walls 44, 46 of the carrier segment 24 each include corresponding channels 52, 54, 56 as shown in FIGS. 5 and 6. The forward support wall 44 is formed to include the first channel 52 and the second channel 54. The second channel 54 is spaced apart axially from the first channel 52 to define the partition wall 58 therebetween. The aft support wall 46 is formed to include the third channel 56 in the illustrative embodiment.

In the illustrative embodiment, only the forward support wall 44 includes the buffer air passageway 50, 51, 53 as shown in FIGS. 5-7. The forward support wall 44 includes at least one discrete buffer air passageway 50, 51, 53 that extends radially into the forward support wall 44 through the partition wall 58 defined axially between the first channel 52 and the second channel 54. In the illustrative embodiment, the forward support wall 44 includes a plurality of buffer air passageways 50, 51, 53 that are spaced apart circumferentially about the axis 11 as shown in FIG. 7.

In the illustrative embodiment, each buffer air passageway 50, 51, 53 extends from an outer cavity 60, 61, 63 formed in the outer wall 40 of the carrier segment 24 as shown in FIGS. 5 and 7. The buffer air flows from the outer cavity 60, 61, 63 to the buffer air passageways 50, 51, 53. In some embodiments, the carrier segment 24 is formed to include an outer cavity 60, 61, 63 for each buffer air passageway 50, 51, 53 that supplies the corresponding buffer air passageway 50, 51, 53 with buffer air.

In the illustrative embodiment, the first and second channels 52, 54 each have a half-heart shape as shown in FIGS. 5 and 6. Each of the buffer air passageways 50, 51, 53 extends through the partition wall 58 defined between the channels 52, 54.

The first channel 52 is defined by a first partition-wall surface 58A of the partition wall 58 and an angled surface 55A as shown in FIG. 6. The first partition-wall surface 58A extends radially outward from the terminal end 58E of the partition wall 58 and curves axially forward moving radially outward. The angled surface 55A extends radially inward and axially forward from the first partition-wall surface 58A.

The second channel 54 is defined by a second partition-wall surface 58B of the partition wall 58 and an angled surface 55B as shown in FIG. 6. The second partition-wall surface 58B extends radially outward from the terminal end 58E of the partition wall 58 and curves axially aft moving radially outward. The angled surface 55B extends radially inward and axially forward from the second partition-wall surface 58B.

The blade track segment 26 includes the shroud wall 70 and the attachment feature 72 as shown in FIGS. 4-6. The shroud wall 70 that extends circumferentially partway around the axis 11. The attachment feature 72 includes a first attachment flange 74 and a second attachment flange 76 that each extend radially outward from the shroud wall 70. The second attachment flange 76 is spaced apart axially from the first attachment flange 74.

In the illustrative embodiment, the forward support wall 44 extends radially inward from the outer wall 40 axially forward of the first attachment flange 74 of the blade track segment 26. The aft support wall 46 extends radially inward from the outer wall 40 axially aft of the second attachment flange 76 of the blade track segment 26. The first intermediate support wall 46 extends radially inward from the outer wall 40 axially aft of the first attachment flange 74 so that the first attachment flange 74 is axially between the forward support wall 44 and the first intermediate support wall 45. The second intermediate support wall 47 extends radially inward from the outer wall 40 axially forward of the second attachment flange 76 of the blade track segment 26 so that the second attachment flange 76 is located axially between the aft support wall 46 and the second intermediate support wall 47.

The mount system 28 includes at least one retainer 78, 80, illustratively two retainers 78, 80 that each extend axially into the blade track segment 26 and the carrier segment 24 to couple the blade track segment 26 to the carrier segment 24. The retainers 78, 80 extend axially into the forward support wall 44, through the first attachment flange 74, the intermediate support walls 43, 45, and the second attachment flange 76, and into the aft support wall 46 of the carrier segment 24 so as to couple the blade track segment 26 to the carrier segment 24.

In the illustrative embodiment, the mount system 28 includes the retainers 78, 80 and corresponding retainer plugs 82, 84 as shown in FIG. 4. Each of the retainer plugs 82 extends into an installation apertures formed in the aft support wall 46 to block removal of the corresponding retainers 78, 80 through the installation apertures in the carrier segment 24.

In the illustrative embodiment, the retainers 78, 80 are both split pins as shown in FIG. 3. Each retainer 78, 80 includes a first pin 78A, 80A and a second pin 78B, 80B arranged axially aft of the first pin 78A, 80A as shown in FIG. 4.

The seal system 30 includes the forward seal assembly 30F and the aft seal assembly 30A as shown in FIGS. 4-7. The forward seal assembly 30F is located radially between the carrier segment 24 and the blade track segment 26 on the forward side of the first attachment flange 74. The aft seal assembly 30A is located radially between the carrier segment 24 and the blade track segment 26 on the aft side of the second attachment flange 76.

The forward seal assembly 30F includes the first seal 32 and the second seal 34 each arranged in a corresponding channel 52, 54 formed in the carrier segment 24. The aft seal assembly 30A includes a plurality of seal members 36A, 36B, 36C arranged in the third channel 56 formed in the carrier segment 24 in the illustrative embodiment. In some embodiments, the aft seal assembly 30A may be similar to the forward seal assembly 30F.

The forward seal assembly 30F includes the first seal member 32 and the second seal member 34 as shown in FIGS. 4-7. The first seal member 32 and the second seal member 34 each extend circumferentially about the axis 11. Each seal member 32, 34 is arranged in a corresponding radially-inward opening channel 52, 54 formed in the carrier segment 24.

In the illustrative embodiment, buffer air is only discharged between the first and second seal members 32, 34 in the forward seal assembly 30F. The carrier segment 24 only includes buffer air passageways 50, 51, 53 at the buffer air seal assembly 30F to discharge buffer air axially between the first and second seal members 32, 34. In some embodiments, the carrier segment 24 may include buffer air passageways 50, 51, 53 that discharge buffer air axially between the seals 36C, 36B, 36C of the aft seal assembly 30A.

A method of assembling and using the turbine shroud segment 22 may include several steps. The method includes arranging the seal members 32, 34, 36A, 36B, 36C of the seal assemblies 30F, 30A in the corresponding channels 52, 54, 56 before arranging the blade track segment 26 adjacent to the carrier segment 24. The method includes arranging the first seal member 32 in the first channel 52, arranging the second seal member 34 in the second channel 54, and arranging the other seal members 36A, 36B, 36C in the third channel 56. The seal members 32, 34, 36A, 36B, 36C may be arranged in the corresponding channels 52, 54, 56, in any order.

Once all the seal members 32, 34, 36A, 36B, 36C are arranged in the corresponding channels 52, 54, 56, the blade track segment 26 is arranged adjacent to the carrier segment 24 so that the seal members 32, 34, 36A, 36B, 36C of the forward and aft seal assemblies 30F, 30A are radially between the carrier segment 24 and the shroud wall 70 of the blade track segment 26 to block gases in the gas path from flowing between the carrier segment 24 and the blade track segment 26. The blade track segment 26 is arranged adjacent to the carrier segment 24 so that the attachment feature 72 extends into the cavity 48. The blade track segment 26 is arranged adjacent to the carrier segment 24 so that the first attachment flange 74 and the second attachment flange 76 extend into sections of the cavity 48.

In some embodiments, the method further includes inserting the retainers 78, 80 into the carrier segment 24 and the blade track segment 26 to couple the blade track segment 26 to the carrier segment 24. The method includes inserting one retainer 78 axially into the carrier segment 24 and through the attachment feature 72 of the blade track segment 26 to couple the blade track segment 26 to the carrier segment 24. The method further includes inserting another retainer 80 axially into the carrier segment 24 and through the attachment feature 72 of the blade track segment 26 to couple the blade track segment 26 to the carrier segment 24. The second retainer 80 is inserted at a location spaced apart circumferentially from the first retainer 78.

The method further includes discharging a flow of buffer air through the at least one buffer air passageway 50, 51, 53. The flow of buffer air is suggested by arrows A in FIGS. 5 and 6. The method may further include discharging the flow of buffer air through the plurality of buffer air passageways 50, 51, 53. The method includes discharging the flow of buffer air through the buffer air passageway 50, 51, 53 axially between the first and second seal members 32, 34 into the first and second channels 52, 54 to urge the first seal member 32 radially inward and axially forward and the second seal members 34 radially inward and axially into engagement with the carrier segment 24 and the blade track segment 26.

The buffer air discharged into the buffer air cavity 49 defined between the two seals 32, 34 establishes a higher pressure P₁ in the buffer air cavity 49 than the pressure P₂ in the region axially forward of the buffer air seal assembly 30F and the pressure P₃ in the cavity 48 as shown in FIG. 6. The pressure P₃ in the cavity 48 is lower than the pressure P₂ in the region axially forward of the buffer air seal assembly 30F radially outward of the gas path 25 as shown in FIG. 6. The buffer air may be provided from the compressor 14 of the gas turbine engine 10.

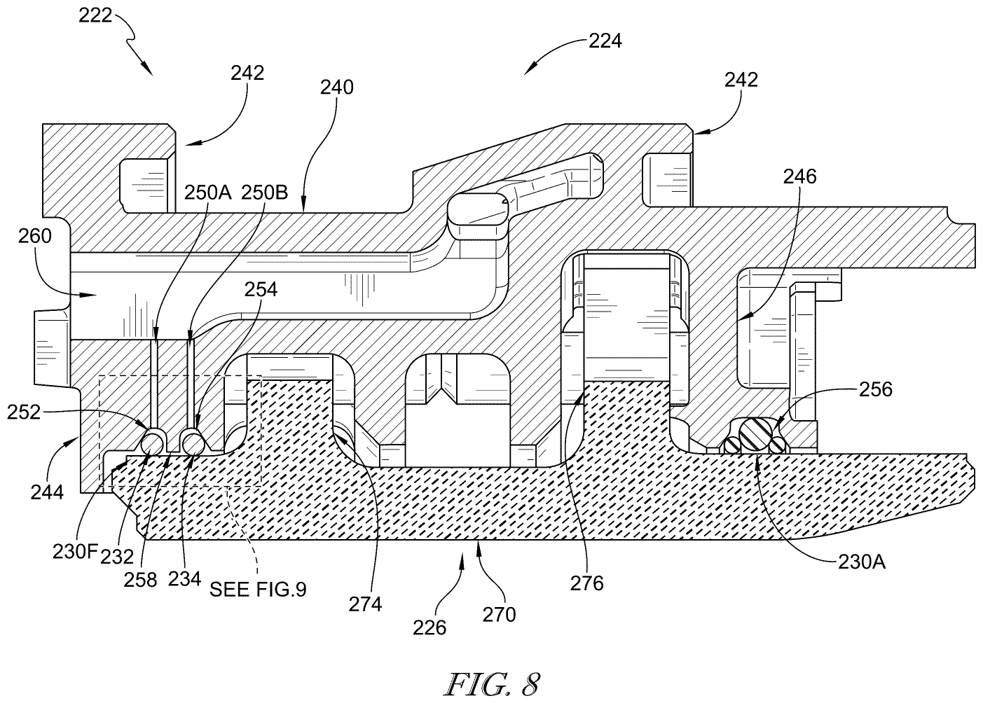

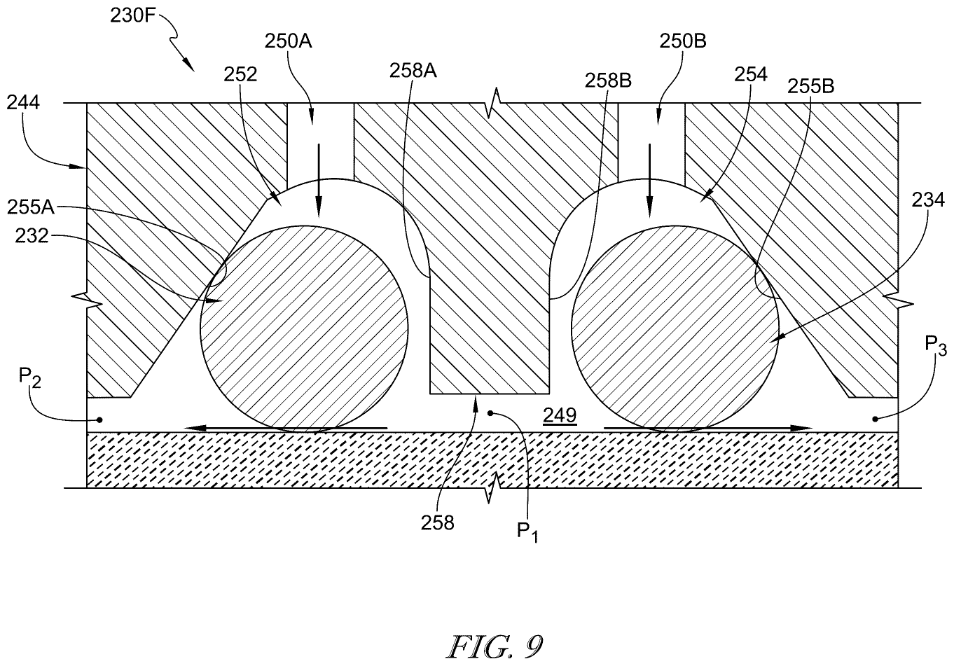

Another embodiment of a turbine shroud segment 222 in accordance with the present disclosure is shown in FIGS. 8 and 9. The turbine shroud segment 222 is substantially similar to the turbine shroud segment 22 shown in FIGS. 1-7 and described herein. Accordingly, similar reference numbers in the 200 series indicate features that are common between the turbine shroud segment 22 and the turbine shroud segment 222. The description of the turbine shroud segment 22 is incorporated by reference to apply to the turbine shroud segment 222, except in instances when it conflicts with the specific description and the drawings of the turbine shroud segment 22.

The turbine shroud segment 222 includes a carrier segment 224 arranged circumferentially at least partway around an axis 11 of the gas turbine engine 10, a blade track segment 226 arranged circumferentially at least partway around the axis 11, a mount system 228 configured to couple the carrier segment 224 to the blade track segment 226, and a seal system 230 as shown in FIGS. 8 and 9. The seal system 230 is configured to seal gaps between the carrier segment 224 and the blade track segment 226 to prevent or block gases from a gas path 25 of the gas turbine engine 10 from flowing between the carrier segment 224 and the blade track segment 226.

The seal system 230 includes a forward seal assembly 230F located radially between the carrier segment 224 and the blade track segment 226 on a forward side of the blade track segment 226 and an aft seal assembly 230A located radially between the carrier segment 224 and the blade track segment 226 on an aft side of the blade track segment 226 as shown in FIGS. 8 and 9. The forward seal assembly 230F—also referred to as the buffer air seal assembly-is arranged in a radially-inwardly opening first channel 252 formed in the forward support wall 244 included on the carrier segment 224, while the aft seal assembly 230A is arranged in a radially-inwardly opening second channel 254 formed in the aft support wall 246 included on the carrier segment 224.

The forward seal assembly 230F includes a first seal member 232 and a second seal member 234 as shown in FIGS. 8 and 9. The first seal member 232 and the second seal member 234 each extend circumferentially about the axis 11. The first seal member 232 is arranged in a first channel 252 formed in the forward support wall 244 of the carrier segment 224. The second seal member 234 is arranged in the second channel 254 formed in the forward support wall 244 of the carrier segment 224. The second channel 254 is spaced apart axially from the first channel 252 to define a partition wall 258 therebetween.

The buffer air discharged into the first and second cavities 252, 254 pressurizes the space or buffer air cavity 249 axially between the first and second seal members 232, 234 to urge the first seal member 132 radially inward and axially forward and the second seal member 134 radially inward and axially aft into engagement with the carrier segment 124 and the shroud wall 270 of the blade track segment 26. However, the buffer air passageways 250A, 250B extend into the forward support wall 244 and open into one of the channels 252, 254 as shown in FIGS. 8 and 9, instead of axially between the channels like in the embodiments of FIGS. 1-7. The buffer air passageways 250A, 250B discharge buffer air axially between the first and second seal members 232, 234 into the first and second channels 252, 254 as suggested by the arrows A, B in FIGS. 8 and 9.

The carrier segment 224 includes an outer wall 240, a pair of hangers 242, a forward support wall 244, and an aft support wall 246 as shown in FIGS. 8 and 9. The outer wall 240 extends circumferentially at least partway about the axis 11. The hangers 242 extend radially outward from the outer wall 240. The forward support wall 244 and the aft support wall 246 each extend radially inward from the outer wall 240 on either side of the attachment flanges 274, 276.

The forward and aft support walls 244, 246 of the carrier segment 24 each include corresponding channels 252, 254, 256 as shown in FIGS. 8 and 9. The forward support wall 244 is formed to include the first channel 252 and the second channel 254. The second channel 254 is spaced apart axially from the first channel 252 to define the partition wall 258 therebetween. The aft support wall 246 is formed to include the third channel 256 in the illustrative embodiment.

The forward support wall 44 includes the buffer air passageways 250A, 250B as shown in FIGS. 8 and 9. The buffer air passageways 250A, 250B extend into the forward support wall 244 and open into one of the channels 252, 254. In the illustrative embodiment, the buffer air passageways 250A, 250B each extend from an outer cavity 260 formed in the outer wall 240 of the carrier segment 224 as shown in FIG. 8.

In the illustrative embodiment, the buffer air passageways 250A, 250B are circumferentially aligned. In some embodiments, the buffer air passageways 250A, 250B may be spaced apart circumferentially. In some embodiments, the forward support wall 244 may be formed to include more than one set of buffer air passageways 250A, 250B. The sets of buffer air passageways may be spaced apart circumferentially relative to the axis 11.

In the illustrative embodiment, the first and second channels 252, 254 each have a half-heart shape as shown in FIGS. 8 and 9. The first and second channels 252, 254 are spaced apart axially to define the partition wall 58 therebetween.

The first channel 252 is defined by a first partition-wall surface 258A of the partition wall 258 and an angled surface 255A as shown in FIG. 9. The first partition-wall surface 258A extends radially outward from the terminal end 258E of the partition wall 258 and curves axially forward moving radially outward. The angled surface 255A extends radially inward and axially forward from the first partition-wall surface 258A.

The second channel 254 is defined by a second partition-wall surface 258B of the partition wall 258 and an angled surface 255B as shown in FIG. 6. The second partition-wall surface 258B extends radially outward from the terminal end 258E of the partition wall 58 and curves axially aft moving radially outward. The angled surface 255B extends radially inward and axially forward from the second partition-wall surface 258B.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine shroud assembly for use with a gas turbine engine, the turbine shroud assembly comprising
a carrier segment arranged circumferentially at least partway around an axis, the carrier segment including an outer wall, a first support wall that extends radially inward from the outer wall, and a second support wall that extends radially inward from the outer wall at a location spaced apart axially from the first support wall to define an attachment-receiving space, and wherein the first support wall is formed to include a radially-inwardly opening first channel that extends circumferentially relative to the axis, a radially-inwardly opening second channel spaced apart axially from the radially-inwardly opening first channel that extends circumferentially relative to the axis, and at least one buffer air passageway that extends radially into the first support wall,
a blade track segment arranged circumferentially at least partway around the axis to define a portion of a gas path of the gas turbine engine, the blade track segment having a shroud wall that extends circumferentially partway around the axis and an attachment feature that extends radially outward from the shroud wall into the attachment-receiving space of the carrier segment, and
a buffer air seal assembly located radially between the carrier segment and the shroud wall of the blade track segment to block gases from flowing between the carrier segment and the blade track segment into the attachment-receiving space of the carrier segment, the buffer air seal assembly including a first seal member arranged in the first channel and engaged with the shroud wall and a second seal member arranged in the second channel and engaged with the shroud wall,
wherein the at least one buffer air passageway discharges buffer air radially inward axially between the first and second seal members into the first channel and the second channel to urge the first seal member radially inward and axially forward and the second seal member radially inward and axially aft into engagement with the carrier segment and the blade track segment.

2. The turbine shroud assembly of claim 1, wherein the first and second channel cooperate to define a partition wall formed in the first support wall axially therebetween that extends circumferentially relative to the axis.

3. The turbine shroud assembly of claim 2, wherein the at least one buffer air passageway extends radially through the partition wall axially between the first channel and the second channel.

4. The turbine shroud assembly of claim 2, wherein the at least one buffer air passageway includes a first buffer air passageway that extends radially into the first support wall and opens into the first channel and a second buffer air passageway that extends radially into the first support wall and opens into the second channel.

5. The turbine shroud assembly of claim 2, wherein the first channel is defined by a first partition-wall surface of the partition wall that extends radially outward from a terminal end of the partition wall and curves axially forward moving radially outward and a first angled surface that extends radially inward and axially forward from the first partition-wall surface.

6. The turbine shroud assembly of claim 5, wherein the second channel is defined by a second partition-wall surface of the partition wall that extends radially outward from the terminal end of the partition wall and curves axially aft moving radially outward and a second angled surface that extends radially inward and axially aft from the second partition-wall surface.

7. The turbine shroud assembly of claim 1, wherein the first seal member and the second seal member each comprise a single strand of solid metallic material.

8. The turbine shroud assembly of claim 1, wherein the aft support wall is formed to include a radially-inwardly opening third channel that extends circumferentially relative to the axis, and the turbine shroud assembly further comprises a third seal member arranged in the third channel.

9. The turbine shroud assembly of claim 1, further comprising at least one retainer that extends axially into the carrier segment and through the attachment feature of the blade track segment so as to couple the blade track segment to the carrier segment.

10. A method comprising:
providing a carrier segment arranged circumferentially at least partway around an axis, the carrier segment formed to include a radially-inwardly opening first channel, a radially-inwardly opening second channel spaced apart axially from the first channel, and at least one buffer air passageway that extends radially into the carrier segment,
providing a blade track segment arranged circumferentially at least partway around the axis, the blade track segment having a shroud wall that extends circumferentially partway around the axis and an attachment feature that extends radially outward from the shroud wall,
providing a buffer air seal assembly including a first seal member and a second seal member that each extend circumferentially relative to the axis,
arranging the first seal member of the buffer air seal assembly in the first channel formed in the carrier segment,
arranging the second seal member of the buffer air seal assembly in the second channel formed in the carrier segment,
arranging the blade track segment adjacent to the carrier segment so that the buffer air seal assembly is radially between the carrier segment and the shroud wall of the blade track segment to block gases from flowing between the carrier segment and the blade track segment, and
discharging a flow of buffer air through the at least one buffer air passageway axially between the first and second seal members into the first channel and the second channel to urge the first seal member radially inward and axially forward and the second seal member radially inward and axially aft into engagement with the carrier segment and the blade track segment.

11. The method of claim 10, wherein the first and second channel cooperate to define a partition wall formed in carrier segment axially therebetween that extends circumferentially relative to the axis.

12. The method of claim 11, wherein the at least one buffer air passageway extends radially through the partition wall axially between the first channel and the second channel.

13. The method of claim 11, wherein the at least one buffer air passageway includes a first buffer air passageway that extends radially into the carrier segment and opens into the first channel and a second buffer air passageway that extends radially into the carrier segment and opens into the second channel.

14. The method of claim 11, wherein the first channel is defined by a first partition-wall surface of the partition wall that extends radially outward from a terminal end of the partition wall and curves axially forward moving radially outward and a first angled surface that extends radially inward and axially forward from the first partition-wall surface, and wherein the second channel is defined by a second partition-wall surface of the partition wall that extends radially outward from the terminal end of the partition wall and curves axially aft moving radially outward and a second angled surface that extends radially inward and axially aft from the second partition-wall surface.

15. The method of claim 10, wherein the first seal member and the second seal member each comprise a single strand of solid metallic material.

16. The method of claim 10, further comprising providing a third seal member and arranging the third seal member in a radially-inwardly opening third channel formed in the carrier segment.

17. The method of claim 10, further comprising providing at least one retainer and inserting the at least one retainer axially into the carrier segment and through the attachment feature of the blade track segment to couple the blade track segment to the carrier segment.
